(19) United States
(12) Patent Application Publication
(10) Pub. No.: US 2023/0151667 A1
(43) Pub. Date: May 18, 2023

(54) ANTI-PINCH SENSOR EASY INSTALL TO FLANGE

(71) Applicants: Christopher J. Kuntze, Goodrich, MI (US); Magna Exteriors Inc., Concord (CA)

(72) Inventor: Christopher J. Kuntze, Goodrich, MI (US)

(73) Assignee: Magna Exteriors Inc., Concord, ON (CA)

(21) Appl. No.: 17/919,440

(22) PCT Filed: Apr. 16, 2021
(86) PCT No.: PCT/US2021/027719

§ 371 Date: Oct. 17, 2022

Related U.S. Application Data
(60) Provisional application No. 63/011,632, filed on Apr. 17, 2020.

(51) Int. Cl. E05F 15/48; B60J 5/10

(52) U.S. Cl. CPC E05F 15/48; B60J 5/107; E05Y 2400/55; E05Y 2900/532; E05Y 2600/46

(57) ABSTRACT

A liftgate for a vehicle having an anti-pinch sensor attached at an outer peripheral area of the liftgate. A liftgate including an outwardly extending flange portion. An anti-pinch sensor mount including a U-shaped cross section which is adapted to fit over and secure to the outwardly extending flange portion. An anti-pinch sensor attached to the mount for sensing an interference in opening or closing of the liftgate and reversing the opening or closing of the liftgate.

### CROSS-REFERENCE TO RELATED APPLICATIONS

This application is a POT International Application and claims benefit of U.S. Provisional Patent Application No. 63/011,632, filed Apr. 17, 2020, The disclosure of the above application is incorporated herein by reference.

### FIELD OF THE INVENTION

The present invention relates to an anti-pinch sensor for a door of a vehicle.

### BACKGROUND OF THE INVENTION

Anti-pinch sensors are often used by automotive OEM's on the sides of a liftgate as a due care type safety item. Such sensors are used on liftgate doors that have a power actuation system, to stop or reverse a door if there is an obstacle in the way. These anti-pinch sensors create additional parts, additional costs, create assembly complexity, packaging concerns, appearance concerns, and quality concerns, Integrating the mounting surface of the anti-pinch sensor to the liftgate inner panel is an improvement over a conventional molded carrier but continuing to use two-sided sticky tape with adhesion promotor and mechanical fasteners as a primary attachment is not the most efficient.

Thus, it is an object of the present invention to reduce complexity, reduce cost, reduce possibility of poor assembly, improve quality, reduce assembly time, reduce weight, improve appearance when providing for a anti-pinch sensor in a vehicle liftgate.

### SUMMARY OF THE INVENTION

A liftgate for a vehicle having an anti-pinch sensor attached at an outer peripheral area of the liftgate is provided. The liftgate includes an outwardly extending flange portion. An anti-pinch sensor mount including a U-shaped cross section which is adapted to fit over and secure to the outwardly extending flange portion. An anti-pinch sensor is attached to the mount for sensing an interference in opening or closing of the liftgate and reversing the opening or closing of the liftgate.

This invention allows for a small easy to mold flange on the inner panel, does not require adhesion promotor, or two-sided sticky tape, has better self-locating features, has better performance and durability for real life testing such as car wash brushes.

Creating a pocket in the extrusion portion of the anti-pinch sensor that allows for easy assembly and locating onto a simple flange.

The present invention provides an open section that allows loading on a flange and is integrated into the anti-pinch sensor extrusion without adding extra components.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of a liftgate having an anti-pinch sensor in accordance with the present invention; and,

FIG. 2 is a detailed sectional view of the anti-pinch sensor area of FIG. 1.

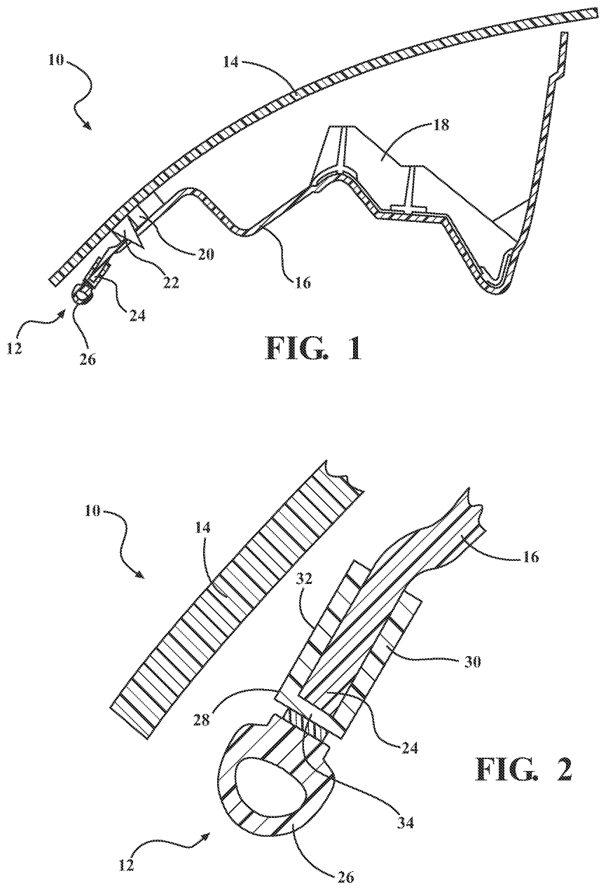

### DETAILED DESCRIPTION OF THE PREFERRED EMBODIMENTS

The following description of the preferred embodiment(s) is merely exemplary in nature and is in no way intended to limit the invention, its application, or uses.

In accordance with the present invention there is provided a liftgate for a vehicle generally shown at 10. The liftgate 10 has an anti-pinch sensor generally shown at 12 attached at an outer peripheral area of the liftgate 10. The liftgate 10 includes an outer show surface panel 14 and an inner panel 16. The inner panel 16 includes reinforcement structure 18. Attachment structure 20, 22 attaches the inner panel 16 to outer panel 14. The inner panel 16 is preferably formed of a filled thermoplastic and includes an outwardly extending flange portion 24.

Anti-pinch sensor 12 includes an outer pinch sensor bulb portion 26 and a pinch sensor mount 28. The mount portion 28 including a U-shaped cross section formed by two outer legs 30 and 32 connected by an inner wall 34 this mount is designed to fit over and secure to the outwardly extending flange portion 24. Preferably the mount portion 28 is adapted for press fitting onto the flange 24. Preferably the anti-pinch sensor bulb 26 and the pinch sensor mount 28 are an elongated one-piece extrusion. Typically, the mount portion 28 is mechanically attached and is of a durometer that will provide enough compression to hold onto the flange 24. However, mount 28 can also be glued to the flange 24 with butyl adhesives or the like if further securement is necessary. Mechanical fasteners, staples and/or crimping of the flange are also used in other embodiments. Additionally, the flange 24 in other embodiments includes a stepped surface or openings which can promote securement of the mount portion 28 onto the flange.

The anti-pinch sensor bulb 26 is attached to the mount portion for sensing an interference in opening or closing of the liftgate and reversing the opening or closing of the liftgate thus the anti-pinch sensor bulb portion 26 is of a softer durometer than the mount to provide proper compression for sensing of an object which interferes with opening or closing of the liftgate.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A liftgate for a vehicle having an anti-pinch sensor attached at an outer peripheral area of the liftgate, comprising:
A liftgate including an outwardly extending flange portion;
An anti-pinch sensor mount including a U-shaped cross section which is adapted to fit over and secure to the outwardly extending flange portion; and,
An anti-pinch sensor attached to the mount for sensing an interference in opening or closing of the liftgate and reversing the opening or closing of the liftgate.

2. The liftgate for a vehicle of claim 1 wherein the anti-pinch sensor mount includes a U-shaped member which is pushed onto an outer peripheral flange and is secured on the flange.

3. The liftgate for a vehicle of claim 2 wherein the liftgate includes an outer show surface panel and an inner panel, wherein the inner panel includes said outer peripheral flange.

4. The liftgate for a vehicle of claim 2 wherein the anti-pinch sensor and the pinch sensor mount are an integral extrusion.

5. The liftgate for a vehicle of claim 4 wherein the mount is of a durometer which allows the mount to hold onto the flange and the bulb is of a durometer which allows the pinch sensor to compress with respect to an object interfering with the opening or closing of the liftgate.

6. The liftgate for a vehicle of claim 5 wherein the mount is additionally secured with adhesive, mechanical fasteners or combinations of adhesive and mechanical fasteners.

7. The liftgate for a vehicle of claim 5 wherein the inner panel is a molded panel having an integrally molded outer flange for engagement of the mount portion of the anti-pinch sensor.

8. A liftgate for a vehicle having an anti-pinch sensor attached at an outer peripheral area of the liftgate, comprising:
A liftgate including an outer show surface panel and an inner panel, wherein the inner panel includes an outer peripheral flange;
An anti-pinch sensor mount including a U-shaped cross section which is adapted to fit over and secure to the outwardly extending flange portion; and,
An anti-pinch sensor attached to the mount for sensing an interference in opening or closing of the liftgate and reversing the opening or closing of the liftgate.

9. The liftgate for a vehicle of claim 8 wherein the anti-pinch sensor mount includes a U-shaped member which is pushed onto an outer peripheral flange and is secured on the flange.

10. The liftgate for a vehicle of claim 9 wherein the anti-pinch sensor and the pinch sensor mount are an integral extrusion.

11. The liftgate for a vehicle of claim 10 wherein the mount is of a durometer which allows the mount to hold onto the flange and the bulb is of a durometer which allows the pinch sensor to compress with respect to an object interfering with the opening or closing of the liftgate.

12. The liftgate having an anti-pinch sensor of claim 8 wherein the outwardly extending flange is provided over pre-selected areas for the outer peripheral flange.

13. The liftgate for a vehicle of claim 8 wherein the inner panel is a molded panel having an integrally molded outer flange for engagement of the mount portion of the anti-pinch sensor.

14. The liftgate having an anti-pinch sensor of claim 8 wherein the outwardly extending flange is provided over the entire outer peripheral area of the liftgate.

15. The liftgate for a vehicle of claim 8 wherein the mount is additionally secured with adhesive, mechanical fasteners or combinations of adhesive and mechanical fasteners.
